(19) United States
(12) Patent Application Publication
(10) Pub. No.: US 2015/0226314 A1
(43) Pub. Date: Aug. 13, 2015

(54) Mixer For Feed

(71) Applicant: Trioliet Holding B.V., Oldenzaal (NL)

(72) Inventor: Cornelis Hendricus Liet, Losser (NL)

(21) Appl. No.: 14/618,104

(22) Filed: Feb. 10, 2015

(30) Foreign Application Priority Data
Feb. 11, 2014 (NL) 2012242

(51) Int. Cl. F16H 57/04; B01F 7/24

(52) U.S. Cl. CPC F16H 57/0416; F16H 57/0413; F16H 57/0486; B01F 7/241

(57) ABSTRACT

A mixer for feed, provided with at least one auger and at least one gearbox with an input drive shaft and an output shaft for driving the auger. The mixer comprises means, such as a fan, for generating an air flow along the gearbox. The gearbox can for instance comprise a right-angle gearbox with or more planetary reduction gearboxes.

### BACKGROUND

The discussion below is merely provided for general background information and is not intended to be used as an aid in determining the scope of the claimed subject matter.

Aspects of the invention relate to a mixer for feed, provided with an auger.

A mixer is usually provided with an auger with a vertical shaft, often provided with one or more spiral mixing blades. The mixer can for instance be made up of a wheeled diet feeder cart commonly pulled by a tractor, in which case the shaft of the auger can be driven by the tractor by way of a power take-off shaft. Alternatively, the mixer can be supported by standards and be driven by an external motor, usually an electric motor. Alternatively, the mixer can be a self-propelled and/or self-loading vehicle.

In the case of larger tractors and electric drives the input shaft is often driven at a speed of 1,000 rpm or higher. In diet feeder carts often gearboxes are used which are composed of a right-angle gearbox, usually connected to one, two or more planetary reduction gearboxes placed one behind the other, in order to reduce the speed to the speed desired for the auger, usually c. 40 rpm maximum. In order to control the temperature of the oil in these comparatively rapidly rotating gearboxes, the gearboxes are provided with an oil tank and a cooling radiator. Such a cooling system uses a lot of oil, as a result of which the maintenance costs are comparatively high.

### SUMMARY

This Summary and the Abstract herein are provided to introduce a selection of concepts in a simplified form that are further described below in the Detailed Description. This Summary and the Abstract are not intended to identify key features or essential features of the claimed subject matter, nor are they intended to be used as an aid in determining the scope of the claimed subject matter. The claimed subject matter is not limited to implementations that solve any or all disadvantages noted in the Background. It is one of the objects of the invention to improve the prior art roof assembly.

An aspect of the invention is to provide a mixer for feed provided with a drive with more favorable oil consumption and lower maintenance costs.

An aspect of the invention is attained with a mixer for feed, which mixer is provided with at least one auger and a gearbox with an input driving shaft and an output shaft for driving the auger. The mixer comprises an air mover for generating an air flow along the gearbox.

In this process heat is dissipated by way of the oil by the air flow. It was found that by using such a combined air and oil cooling, oil consumption and maintenance costs are lowered substantially. The use of an oil tank, radiator, hoses and the like can be avoided. At an input speed of 1,000 rpm a lot of heat is generated, especially in the case of the right-angle gearing, where the speed is highest, and to a lesser degree in the planetary reduction gearboxes. It was found that so much heat is generated that the temperature of the lubricating oil used can rise to far above 90 degrees in the case of continuous use. In such a case the oil will age rapidly as a result of combustion and will no longer provide sufficient lubrication. The seals will also age quickly and the gearbox will suffer damage. With a system as described herein excess heating of the oil is prevented in an economically advantageous manner, as a result of which it no longer has to be replaced or has to be replaced less frequently. A cooling radiator is no longer required and the maintenance costs are low.

These advantages are not attained using already familiar cooling systems where oil is circulated through the gearboxes by way of an oil pump, after which the oil is passed through a heat exchanger. In that process heat is dissipated with the aid of a fan. The cooled oil is then returned to the gearboxes. Such a system is relatively expensive as a result of the use of a pump with a suction filter, an oil tank and a fan. Such a system has a large oil capacity. Replacing the oil thus increases the maintenance costs. Surprisingly, it was found that an air flow along the right-angle gearbox itself has sufficient effect on the temperature and on the oil's keeping properties, with it being possible to use a simpler design which has lower maintenance costs.

The gearbox can for instance comprise one or more reduction gearboxes, with the input and output shafts being essentially parallel. Alternatively, the gearbox can comprise a right-angle gearbox, with the output shaft being a vertical shaft for driving the auger by way of one or more reduction gearboxes. The reduction gearboxes serve to further reduce the speed of the rotation of the output shaft and can for instance comprise one or more, say two, planetary reduction gearboxes. The air flow can be passed along these reduction gearboxes as well.

The air mover for generating an air flow can for instance comprise a fan on the underside of the right-angle gearbox. In that case the fan can be arranged such that the air flow along the right-angle gearbox is directed downwards. This prevents dirt from the environment or from the floor being sucked upwards in the direction of the gearbox or the reduction gearboxes. Alternatively, the air flow can be generated parallel to the horizontal shafts.

Oil for lubricating the right-angle reduction gearing can be circulated by way of an oil circuit which extends partly outside the right-angle gearbox and in the process crosses the range of the generated air flow. In the range of the air flow the circulated oil cools, which can then be returned to the gearing to be cooled. Such an oil circuit can for instance comprise a spiral line in the range between the right-angle gearbox and the fan.

The right-angle reduction gearing usually comprises a first conical gear mounted on the drive shaft and, mating with the first conical gear, a second conical gear which is mounted on the output shaft and meshes with the first conical gear which is at right angles to it. The section of the oil circuit extending outside the right-angle gearbox preferably connects to an opening in the gearbox near the mesh point of the two right-angle conical gears, more particularly at a point which—looking in the direction of rotation of the gears—is behind the mesh point of the conical gears. The right-angle reductive gearing has a driving, pumping action by which the oil can be driven by way of the said opening into the external part of the oil circuit. Because of this there is no need to use a pump and the oil can be circulated in an efficient manner.

For a still more efficient temperature control the device can be provided with one or more temperature sensors on one or more of the parts of the device which are under thermal load, and a control unit for controlling the air mover for generating an air flow on the basis of a signal generated by the sensor, or for triggering an alarm.

The air mover for generating an air flow can for instance be driven with the aid of an electric motor or with the aid of a mechanical drive.

### BRIEF DESCRIPTION OF THE DRAWINGS

Aspects of the invention will be elucidated further with reference to the drawings.

FIG. 1: is a cross-sectional representation of a diet feeder cart connected to a tractor shown in side view;

FIG. 2: is a representation in side view of an alternative, stationary mixer according to the invention;

FIGS. 3a and b: are representations in perspective of a drive of the mixer according to FIG. 1 or FIG. 2 with and without a casing, respectively;

FIG. 4: is a cross-sectional representation of the drive of FIG. 1 or 2;

FIG. 5: is a cross-sectional representation of an alternative potential drive;

FIG. 6: is a representation in side view of a further alternative embodiment of a mixer;

FIG. 7: is a representation in rear view of the mixer of FIG. 6.

### DETAILED DESCRIPTION OF THE ILLUSTRATIVE EMBODIMENTS

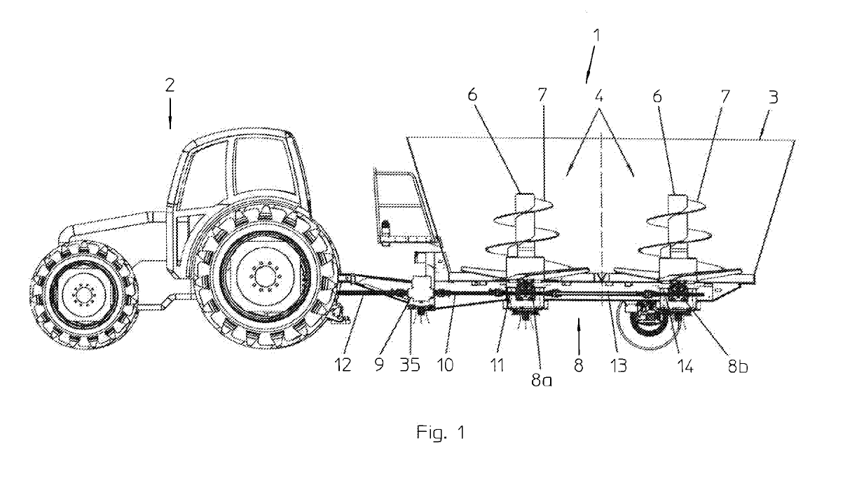

FIG. 1 shows a diet feeder cart 1 for mixing feed connected to a tractor 2. In the embodiment illustrated, the diet feeder cart 1 comprises a mixing bin 3 with two vertical augers 4, both equipped with a vertical augur column 6 with a spiral mixing ribbon 7. Other embodiments with a single auger 4 or with more than two augers 4 can also be used.

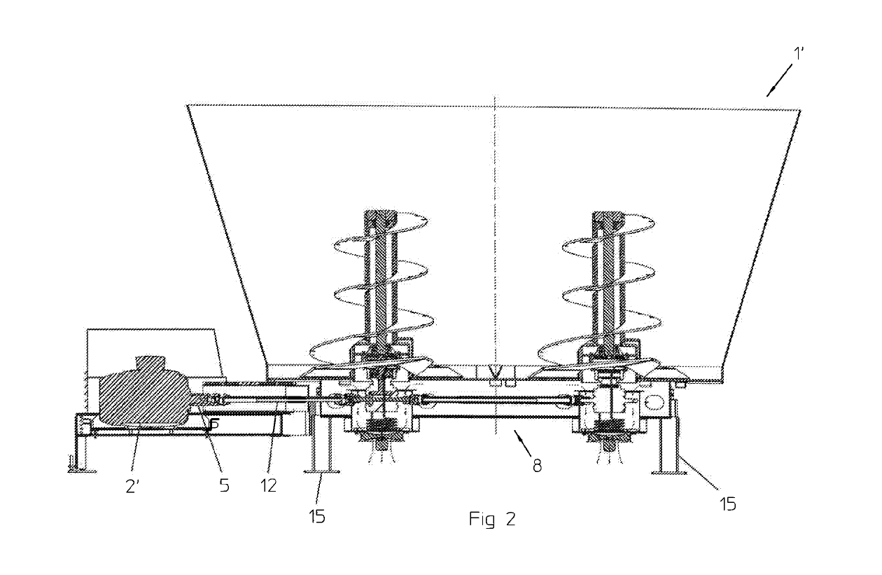

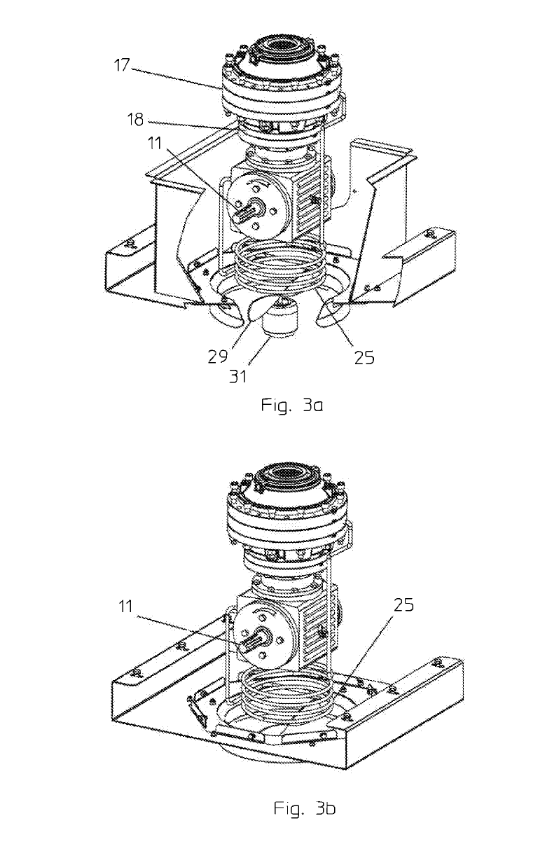

The front auger 4 is driven with the aid of a right-angle reduction gearing 8a shown in FIGS. 2 and 3. This gearing 8a comprises an essentially horizontal input drive shaft 10 with a first end that can be linked by way of a reduction gearbox 9 to an intermediate power take-off shaft 12, which is linked to the power take-off shaft of the tractor 2 (not shown) or a different external drive. A second end of the input shaft 10 is linked to a second intermediate power take-off shaft 13, which is linked to an input shaft 14 of a second right-angle reduction gearing 8b for driving the rear auger 4. Collectively, gearing 8a and 8b are identified at 8.

FIG. 2 shows a mixer 1′, which is not configured as a cart but is supported by standards 15. The mixer 1′ is not connected to a tractor, but to an electric drive 2′ with an output shaft 5. Otherwise the configuration embodiment is the same as that of FIG. 1.

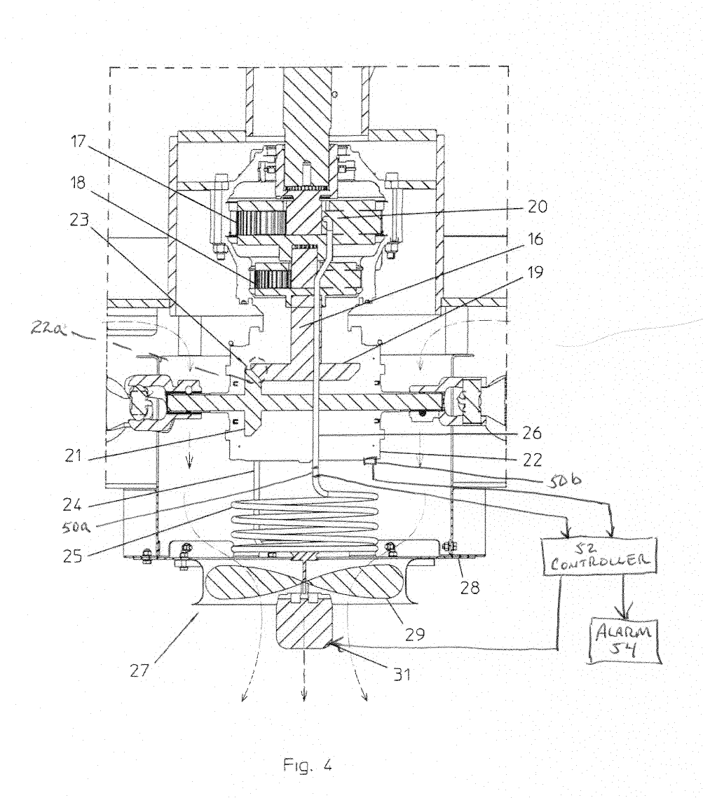

The right-angle reduction gearing 8a further comprises a vertical output shaft 16 (see FIG. 4), which drives the auger column 6 of the auger 4 by way of two planetary gearboxes 17, 18. The bottom end of the vertical shaft 16 is provided with an integrally shaped conical gear 19, which mates with a conical gear 21 on the input drive shaft 10. The two conical gears 19, 21 form a right-angle gearing which is incorporated in a gearbox 22, where the input shaft 10 extends both at the front and at the rear side (i.e. through the gearbox 22) and where the vertical shaft 16 extends at the top of the gearbox 22 and forms the drive shaft for the two planetary gearboxes 17, 18 mounted above it one behind the other.

The right-angle reduction gearing 8a is lubricated with oil in the gearbox 22. Near the mesh point 23 of the two conical gears 19, 21 the oil is discharged into an oil circuit by way of an opening 22a (illustrated schematically with a dashed circle behind the mesh point 23) in the gearbox 22 proximate moving components of the gearing 8a to receive oil therefrom, for example, with the aid of the driving action of the two meshing conical gears 19, 21. By way of the oil circuit having the opening 22a in the gearbox 22 and successively comprising, a vertical oil line 24, a spiral circuit section 25 and a vertical line 26, the oil is returned to an oil line opening 20 in the area of the planetary gearboxes 17, 18, where the oil is returned once more to the gearbox 22. As a result of this structure and action, a recirculation circuit for the oil is created. The spiral circuit section 25 is in line with an opening 27 in a base plate 28 of the diet feeder cart 1. In this opening 27 a fan 29 has been mounted, which is driven by an electric motor 30. When the fan 29 is in operation, it sucks in air. The air flow, indicated in the figure by the arrows, is directed downwards, so that air is guided along outer walls of the gearbox 22 of the gearing 8a. The gearbox 22 is cooled by this. The air flow also passes by portion(s) of the oil circuit such as through the spiral section 25 of the oil circuit. This ensures that the oil in the circuit is properly cooled before it is passed back to the oil inlet 20 in the gearbox 22. This way a very effective combined air and oil cooling is obtained.

Referring back to FIG. 1, reduction gearbox 9, of which the input shaft which connects to the intermediate power take-off shaft 12 is essentially parallel to the output shaft which connects to the drive shaft 10, is provided with a fan 35, which generates a downwards directed air flow.

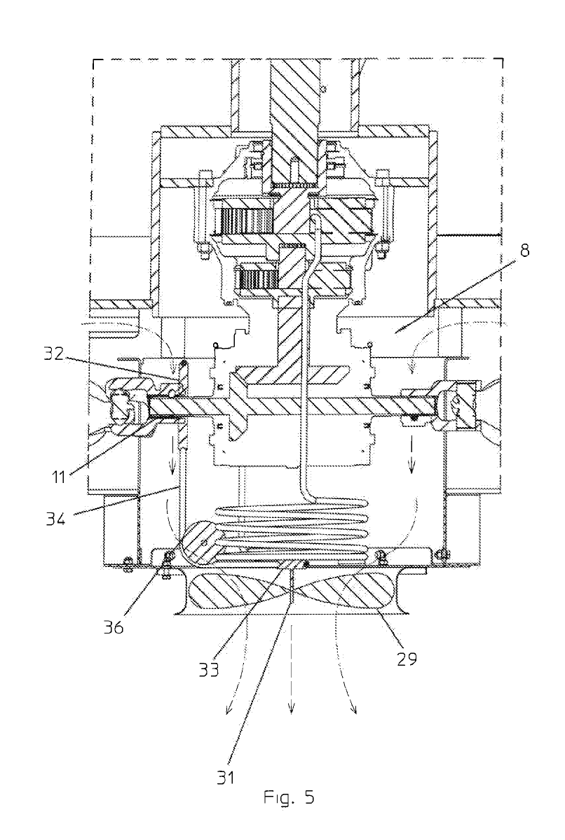

FIG. 5 shows an alternative embodiment of the right-angle reduction gearing 8a, 8b which is equal to the embodiment of FIG. 4, except for the drive of the fan 29. The fan 29 in this case is not driven by an electric motor but by a mechanical drive herein illustrated as a belt drive although other forms such as but not limited to by gears and drive shafts or drive cables. In this case both the input shaft 10 and the rotor shaft 31 of the fan 29 comprise a pulley disc 32, 33 along which a belt 34 is guided by way of two parallel reverse pulleys 36 that guide the belt 34 between vertical and horizontal movements. In FIG. 5, the belt 34 is cut to illustrate one horizontal/vertical section guided by pulley 36. A second pulley (not shown) is disposed in front of the pulley 36 illustrated in FIG. 5 so as to guide the belt 34 in a similar horizontal/vertical section (not shown). By way of the belt 34, the rotor shaft 31 of the fan 29 is rotatably driven by the rotation of the input shaft 10.

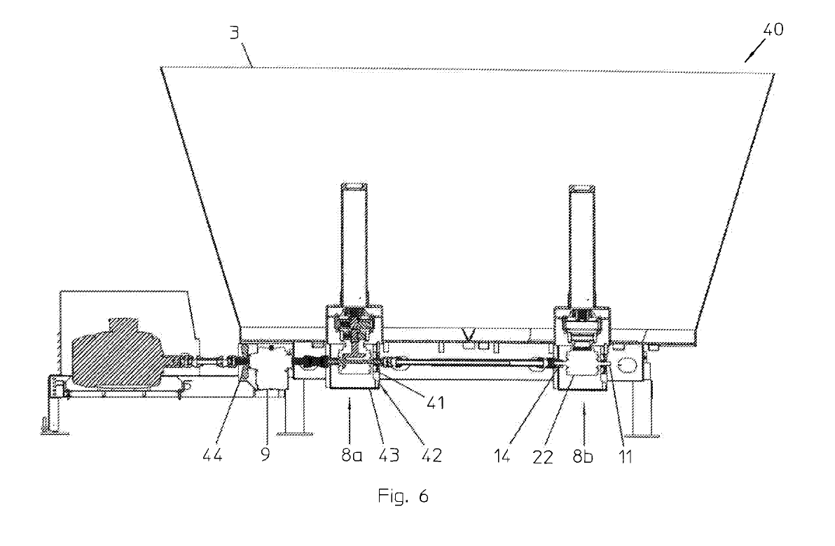

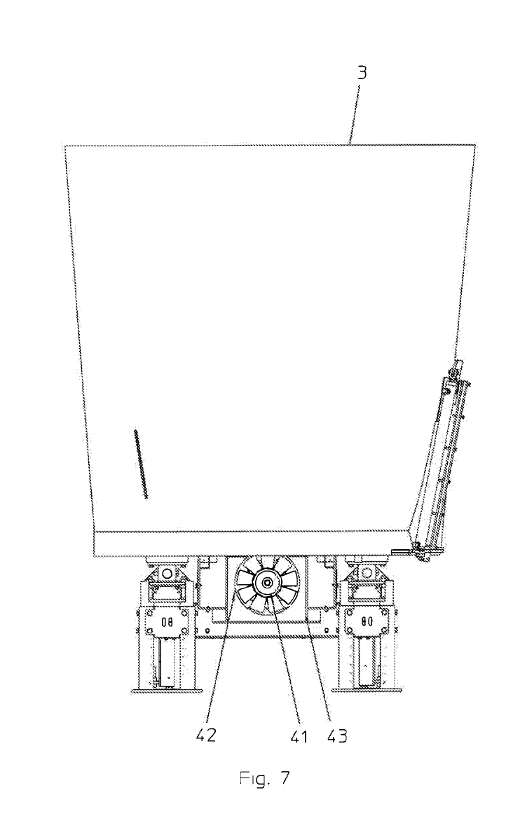

An alternative mixer 40 is shown in FIGS. 6 and 7. This mixer 40 also comprises a mixing bin 3. In the mixing bin 3 there are augers, not shown, but similar to the augers illustrated in FIG. 2, which are driven by way of two gearings 8a, 8b supported by standards 15. In this embodiment the input shaft 10 is provided with an impeller or fan 41, which rotates with the shaft 10. As shown in FIG. 8, the impeller 41 is mounted in an opening 42 in a casing 43 around the gearbox 22. The rotation of the impeller 41 makes the impeller 41 suck air by way of the opening 42 into the casing 43, where the air is guided along the gearbox casing 22, after which the air leaves the casing 43 again on the other side. The right-angle reduction gearing 8 of the second auger 4 can also be provided with such an impeller.

In this embodiment also the reduction gearbox 9 between the intermediate power take-off shaft 12 and the drive shaft 10 is provided with a fan 44, which in this embodiment is mounted on the input shaft of the reduction gearbox 9. The fan 44 is arranged to generate an air flow along the outside of the reduction gearbox 9.

For a still more efficient temperature control the apparatus can be provided with one or more temperature sensors 50a, 50b, schematically illustrated, that can be inside or outside the gearbox 22, on a part of the oil circuit 24, 25, 26, and/or on one or more of the parts of the apparatus which are under thermal load. A control unit or controller 52 embodied with analog and/or digital circuitry, which can include a microprocessor with memory and software receives the signal(s) from the sensor(s) 50a, 50b and is configured to control operation of the air mover, for example by controlling operation of motor 31. In addition or in the alternative, the controller 52 can trigger an alarm 54 on the mixer 1 and/or the tractor 2. If desired, a single controller 52 can be used to receive temperature signals from more than one the gearing 8a, 8b and/or 9 on the mixer 1.

Although the subject matter has been described in language specific to structural features and/or methodological acts, it is to be understood that the subject matter defined in the appended claims is not necessarily limited to the specific features or acts described above as has been held by the courts. Rather, the specific features and acts described above are disclosed as example forms of implementing the claims.

What is claimed is:

1. A mixer for feed, comprising:
at least one auger;
at least one gearbox with an input drive shaft and an output shaft operably connected to the auger; and
an air mover mounted proximate the gearbox and configured to generate an air flow along an outer surface of the gearbox.

2. The mixer according to claim 1, wherein the gearbox comprises a right-angle gearbox, wherein the output shaft is a vertical shaft connected to one or more reduction gearboxes that are connected to the auger.

3. The mixer according to claim 2, wherein the air mover is configured to guide the air flow along the one or more reduction gearboxes).

4. The mixer according to claim 1, wherein the input and output shafts are essentially parallel.

5. The mixer according to claim 2, wherein the gearboxes comprise one, two or more planetary reduction gearboxes.

6. The mixer according to claim 1, wherein the air mover comprise a fan mounted on the underside of the gearbox, wherein the fan is configured such that the air flow along the gearbox is directed downwards.

7. The mixer according to claim 1, wherein the gearbox is lubricated or cooled with oil which circulates by way of an oil circuit which extends at least in part outside the gearbox and in the the generated air flow.

8. The mixer according to claim 7, wherein the oil circuit comprises a spiral line disposed between the gearbox and the fan.

9. The mixer according to claim 8, wherein the section of the oil circuit outside the gearbox connects to an opening in the gearbox near a mesh point of two right-angle conical gears.

10. The mixer according to claim 1 comprising one or more temperature sensors on one or more of the parts under thermal load of the gearbox, and a control unit configured to control the air mover on the basis of a signal generated by the one or more sensors and/or for an alarm.

11. The mixer according to claim 1, and further comprising an electric motor or a mechanical drive connected to the air mover.

12. The mixer according to claim 11, wherein the mechanical drive comprises a belt guided around a first pulley on the drive shaft and around a second pulley on a rotor shaft of the air mover.

13. The mixer according to claim 1, wherein the air mover comprise an impeller mounted on the input drive shaft.

14. The mixer according to claim 1 wherein the mixer is a wheeled diet feeder cart, wherein the input drive shaft of the gearbox is provided with a connection configured to connect to a power take-off shaft system of a tractor.
